(19) United States
(12) Patent Application Publication
(10) Pub. No.: US 2026/0080557 A1
(43) Pub. Date: Mar. 19, 2026

(54) OBJECT DESCRIPTOR TOKENS WITH OBJECT TOKENS FOR OBJECT DETECTION

(71) Applicant: QUALCOMM Incorporated, San Diego, CA (US)

(72) Inventors: Varun Ravi Kumar, San Diego, CA (US); Venkatraman Narayanan, Northville, MI (US); Senthil Kumar Yogamani, San Diego, CA (US)

(21) Appl. No.: 18/887,235

(22) Filed: Sep. 17, 2024

(51) Int. Cl. G06T 7/70; G06V 10/44; G06V 10/54; G06V 10/764; G06V 10/82

(52) U.S. Cl. CPC G06T 7/70; G06V 10/44; G06V 10/54; G06V 10/764; G06V 10/82; G06V 2201/07

(57) ABSTRACT

A device for object detection includes one or more memories configured to store image data; and processing circuitry connected to the one or more memories, the processing circuitry configured to: generate bird's-eye-view (BEV) object feature data from the image data, including BEV object tokens, the BEV object tokens being indicative of a first set of information used for object detection in the image data; generate an input for a transformer encoder based on at least some of the BEV object feature data or the image data; generate object descriptor tokens based on applying the transformer encoder to the input, the object description tokens being indicative of a second set of information used for object detection in the image data, the second set of information being usable for classifying real objects; and output object detection information based on the BEV object tokens and the object descriptor tokens.

### TECHNICAL FIELD

This disclosure relates to object detection.

### BACKGROUND

Computer vision applications, including applications in automotives, make use of the detection and analysis of three-dimensional (3D) objects and their velocities. 3D object detection may include the identification and localization of objects in 3D space using sensors like cameras, LiDAR, and radar. Algorithms process this data to recognize and position objects accurately, enhancing real-time situational awareness.

### SUMMARY

In general, this disclosure describes techniques of utilizing object descriptor tokens in addition to object tokens for performing object detection in image data. Processing circuitry may generate the object tokens as part of an object detection pipeline. However, for the object descriptor tokens, the processing circuitry may apply a trained transformer encoder to generate object descriptor tokens usable for classifying real objects. An object transformer and decoder may be configured to perform object detection based on the object descriptor tokens and the object tokens.

In some object detection pipelines, the object tokens used for object detection may include feature data for spoof objects (e.g., objects that are not present) and may not include feature data for long-range objects (e.g., real object that are not proximate). With the use of the trained transformer encoder that generates object descriptor tokens usable for classifying real objects, the processing circuitry may detect real near-range and long-range objects, and avoid detecting spoof objects. That is, the example techniques may improve the overall object detection technology by better detecting real objects and avoiding classifying spoof objects as real objects.

In one example, this disclosure describes a device for object detection, the device comprising: one or more memories configured to store image data; and processing circuitry connected to the one or more memories, the processing circuitry configured to: generate bird's-eye-view (BEV) object feature data from the image data, including BEV object tokens, the BEV object tokens being indicative of a first set of information used for object detection in the image data; generate an input for a transformer encoder based on at least some of the BEV object feature data or the image data; generate object descriptor tokens based on applying the transformer encoder to the input, the object description tokens being indicative of a second set of information used for object detection in the image data, the second set of information being usable for classifying real objects; and output object detection information based on the BEV object tokens and the object descriptor tokens.

In one example, the disclosure describes a method of object detection, the method comprising: generating, with processing circuitry, bird's-eye-view (BEV) object feature data from image data, including BEV object tokens, the BEV object tokens being indicative of a first set of information used for object detection in the image data; generating, with the processing circuitry, an input for a transformer encoder based on at least some of the BEV object feature data or the image data; generating, with the processing circuitry, object descriptor tokens based on applying the transformer encoder to the input, the object description tokens being indicative of a second set of information used for object detection in the image data, the second set of information being usable for classifying real objects; and outputting, with the processing circuitry, object detection information based on the BEV object tokens and the object descriptor tokens.

In one example, the disclosure describes one or more computer-readable storage media storing instruction thereon that when executed cause processing circuitry to: generate bird's-eye-view (BEV) object feature data from image data, including BEV object tokens, the BEV object tokens being indicative of a first set of information used for object detection in the image data; generate an input for a transformer encoder based on at least some of the BEV object feature data or the image data; generate object descriptor tokens based on applying the transformer encoder to the input, the object description tokens being indicative of a second set of information used for object detection in the image data, the second set of information being usable for classifying real objects; and output object detection information based on the BEV object tokens and the object descriptor tokens.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle in accordance with the techniques of this disclosure for object detection in accordance with one or more examples described in this disclosure.

FIG. 2 is a block diagram illustrating an example processing system in accordance with one or more examples described in this disclosure.

FIG. 3 is a flow diagram illustrating an example of training a transformer encoder in accordance with one or more examples described in this disclosure.

FIG. 4 is a flow diagram illustrating an example of object detection in accordance with one or more examples described in this disclosure.

FIG. 5 is a flowchart illustrating an example method for object detection in accordance with one or more examples described in this disclosure.

### DETAILED DESCRIPTION

Performing object detection is beneficial for safe path planning and decision making in autonomous driving systems and advanced driver assistance systems (ADAS) for a vehicle. To perform object detection, processing circuitry (e.g., of an ADAS system) may implement an object detection pipeline that receives camera images and point cloud data (e.g., from a LiDAR). As part of the object detection pipeline, an object encoder may generate object tokens that include feature data useable for object detection. An object decoder receives the object tokens, and generates object information indicative of detected objects.

Some issues with such techniques may be that the object encoder is not well-suited to generate object tokens with feature data that excludes spoof objects or generate object tokens with feature data that includes long-range objects (e.g., objects that are relatively distant from the vehicle). This disclosure describes example techniques that include using a trained transformer encoder that is specifically trained to generate object token descriptors with feature data that can be used to classify an object as real or not, as well as identify long-range objects. An object transformer and decoder may receive the object tokens and the object token descriptors to generate object detection information which tends to more accurately identify real objects, including long-range objects, as compared to relying on object tokens without object descriptor tokens.

Spoof objects may be objects that are not actually present (e.g., virtual objects), but may be incorrectly detected by the processing circuitry. For instance, reflections of objects, objects that are on a billboard, etc. may be considered as spoof objects as these objects are not actually present. Some spoof objects may be from intentional spoofing attacks. Some current object detection techniques do not operate well in differentiating between real objects and reflections or other virtual objects, risking misinterpretations and safety hazards. Also, while multi-sensor fusion, like LiDAR, may assist in reducing detection of near-field spoof objects, more complex ones (e.g., vehicles on billboards) require specialized attention.

For long-range objects, the limited resolution and narrow field of view of camera images, coupled with reduced effectiveness of LiDAR in detecting distant objects due to sparsity of the points in the point cloud generated by the LiDAR, create object detection challenges. Moreover, factors like low light, glare, adverse weather, and object occlusions further impede object detection performance in urban or highway settings with dynamic traffic scenarios.

To address such issues, this disclosure describes example technique of utilizing a transformer encoder to generate object detector tokens usable for classifying real objects, including long-range objects. For instance, the transformer encoder may be trained using a sensor-specific knowledge database that includes a repository of annotated samples encompassing diverse long-range objects and environmental conditions. The result of the training may be a transformer encoder that generates object detector tokens that an object transformer and decoder can utilize, in addition to the object tokens generated as part of the object detection pipeline, for object detection.

In one or more examples, the object detection operations may occur in a bird's-eye-view (BEV) representation. The BEV representation is effectively a representation of the image data if looked down upon.

Accordingly, in one or more examples, the processing circuitry may generate BEV object feature data from the image data, including BEV object tokens. The BEV object tokens may be indicative of a first set of information used for object detection in the image data. The processing circuitry may generate an input for a transformer encoder based on at least some of the BEV object features. For instance, in some examples, the processing circuitry may apply a neural radiance fields (NeRF) for 3D reconstruction to generate a richer scene representation, where the result of the NeRF is the input for the transformer encoder. However, other techniques may be used to generate the input or the BEV object feature data may be input for the transformer encoder.

The processing circuitry may generate object descriptor tokens based on applying the transformer encoder to the input, the object description tokens being indicative of a second set of information used for object detection in the image data. For example, the second set of information may be usable for classifying real objects. The processing circuitry may output object detection information based on the BEV object tokens and the object descriptor tokens.

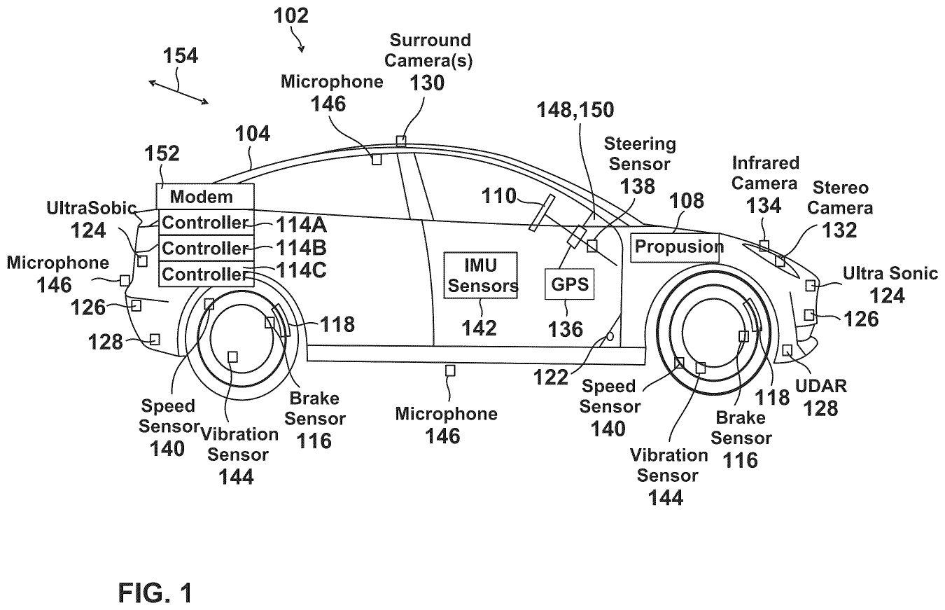

FIG. 1 shows an example vehicle 102. Vehicle 102 in the example shown may comprise a passenger vehicle such as a car or truck that can accommodate a human driver and/or human passengers. In one example, vehicle 102 may comprise an autonomous vehicle, semi-autonomous vehicle and/or an ADAS. Vehicle 102 may be referred to as an “ego” vehicle. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In one example, an actuation controller may include dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in one example, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller 114 has identified the presence of a stop sign, caution sign, or changing traffic light and is taking appropriate action, giving the vehicle occupants peace of mind that the controller 114 is functioning as intended. In one example, instrument cluster 148 may include a separate controller/processor configured to perform deep learning and artificial intelligence functionality.

Vehicle 102 may collect data that is preferably used to help train and refine the neural networks used for autonomous driving, as well as receive trained neural network models. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

It should be noted that, compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

In one example, controller 114 may be configured to output object detection information for one or more objects near-range or long-range of vehicle 102 based on both video data received from one or more of cameras 130-134 (e.g., monocular video) as well as ranging sensor information received from a ranging sensor, such as ultrasonic sensors 124, RADAR sensors 126, LiDAR sensors 128, or any other ranging sensor capable of producing returns indicative of a predicted range/position of an object.

In one specific example, as will be explained in more detail below, controller 114 may be configured to generate a first set of bird's-eye-view (BEV) feature data based on point cloud data (e.g., from LiDAR sensors 128) and a second set of BEV feature data based on the camera image data (e.g., from one or more of cameras 130-134). Techniques to generate the first set of BEV feature data and the second set of BEV feature data is described in more detail.

Controller 114 may generate BEV object feature data based on the first set of BEV feature data and the second set of BEV feature data. The BEV object feature data may include BEV object tokens. The BEV object tokens may be indicative of a first set of information used for object detection in the image data.

Controller 114 may generate object descriptor tokens based on applying a transformer encoder to an input. The input for the transformer encoder may be based on the BEV object feature data. In accordance with one or more examples, the object description tokens may be indicative of a second set of information used for object detection in the image data. The second set of information may be usable for classifying real objects, including long-range objects, or classifying objects as not real objects (e.g., spoof objects).

Controller 114 may output object detection information based on the BEV object tokens and the object descriptor tokens. For instance, some techniques output object detection information based on the BEV object tokens. Such techniques may not be well suited in detecting long-range objects or may incorrectly detect spoof objects. With the use of object descriptor tokens, the example techniques may improve the ability of controller 114 in detecting real objects, including long-range objects.

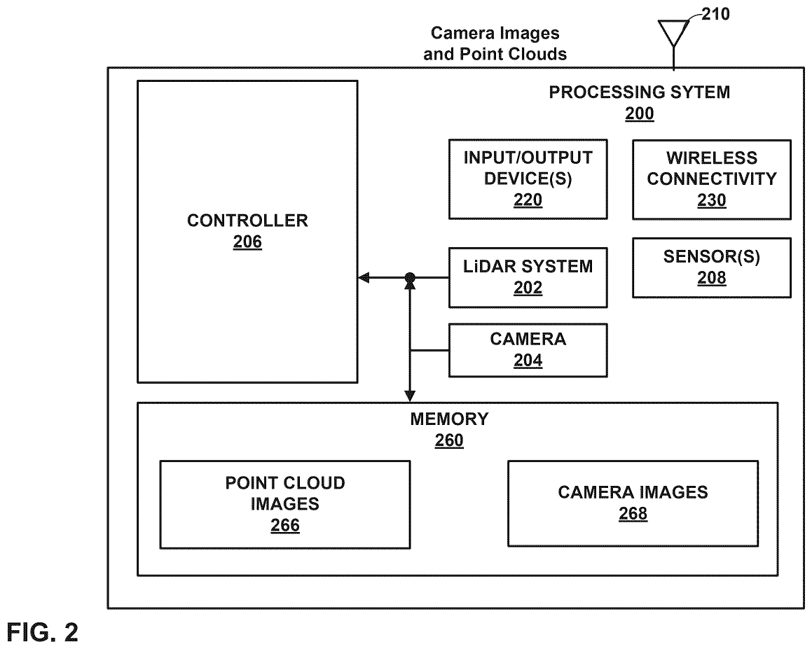

FIG. 2 is a block diagram illustrating an example processing system according to one to more aspects of this disclosure. Processing system 200 may be part of a vehicle, robotics system, drone system, or other systems that use image content for predicting motion. For example, processing system 200 may be part of vehicle 102 of FIG. 1. For ease of description, some of the components illustrated in FIG. 1 are re-illustrated and described with respect to FIG. 2.

In the example of FIG. 2, the one or more sensors of processing system 200 include LiDAR system 202, camera 204, and sensors 208, which may be similar to or the same as corresponding components in FIG. 1. For ease of illustration and description, the example techniques are described with respect to LiDAR system 202 and camera 204. However, the example techniques may be applicable to examples where there is one sensor. The example techniques may also be applicable to examples where different sensors are used in addition to or instead of LiDAR system 202 and camera 204.

Processing system 200 may also include controller 206, which is an example of controller 114 of FIG. 1, input/output device(s) 220, wireless connectivity component 230, such as modem and other components described in FIG. 1, and memory 260. LiDAR system 202 may include one or more light emitters (e.g., lasers) and one or more light sensors. LiDAR system 202 may be deployed in or about a vehicle. For example, LiDAR system 202 may be mounted on a roof of a vehicle, in bumpers of a vehicle, and/or in other locations of a vehicle. LiDAR system 202 may be configured to emit light pulses and sense the light pulses reflected off of objects in the environment. LiDAR system 202 may emit such pulses in a 360 degree field around so as to detect objects within the 360 degree field, such as objects in front of, behind, or beside a vehicle. While described herein as including LiDAR system 202, it should be understood that another distance or depth sensing system may be used in place of LiDAR system 202. The output of LiDAR system 202 are called point clouds or point cloud frames.

A point cloud frame output by LiDAR system 202 is a collection of 3D data points that represent the surface of objects in the environment. These points are generated by measuring the time it takes for a laser pulse to travel from the sensor to an object and back. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization. Intensity values can be used to generate a grayscale image of the point cloud, helping to highlight the structure and features in the image content of a scene.

Color information in a point cloud is usually obtained from other sources, such as digital cameras (e.g., camera 204) mounted on the same platform as the LiDAR sensor, and then combined with the LiDAR data, as described in more detail. The color attribute consists of color values (e.g., red, green, and blue (RGB)) values for each point. The color values may be used to improve visualization and aid in enhanced classification (e.g., the color information can aid in the classification of objects and features in the scene, such as vegetation, buildings, and roads.)

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera 204 may be any type of camera configured to capture video or image data in the scene (e.g., environment) around processing system 200 (e.g., around a vehicle). For example, camera 204 may include a front facing camera (e.g., a front bumper camera, a front windshield camera, and/or a dashcam), a back facing camera (e.g., a backup camera), side facing cameras (e.g., cameras mounted in sideview mirrors). Camera 204 may be a color camera or a grayscale camera. In some examples, camera 204 may be a camera system including more than one camera sensor. While techniques of this disclosure will be described with reference to a 2D photographic camera, the techniques of this disclosure may be applied to the outputs of other sensors that capture information at a higher frame rate than a LiDAR sensor, including examples of the one or more sensors 208, such as a sonar sensor, a radar sensor, an infrared camera, and/or a time-of-flight (ToF) camera.

Wireless connectivity component 230 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 230 is further connected to one or more antennas 210.

Processing system 200 may also include one or more input and/or output devices 220, such as screens, touch-sensitive surfaces (including touch-sensitive displays), physical buttons, speakers, microphones, and the like. Input/output device(s) 220 (e.g., which may include an I/O controller) may manage input and output signals for processing system 200. In some cases, input/output device(s) 220 may represent a physical connection or port to an external peripheral. In some cases, input/output device(s) 220 may utilize an operating system. In other cases, input/output device(s) 220 may represent or interact with a modem, a keyboard, a mouse, a touchscreen, or a similar device. In some cases, input/output device(s) 220 may be implemented as part of controller 206. In some cases, a user may interact with a device via input/output device(s) 220 or via hardware components controlled by input/output device(s) 220.

Controller 206 may be an autonomous or assisted driving controller (e.g., an ADAS) configured to control operation of processing system 200 (e.g., including the operation of a vehicle). For example, controller 206 may control acceleration, braking, and/or navigation of the vehicle through the scene (e.g., environment surrounding the vehicle). Controller 206 may include processing circuitry. The processing circuitry may include one or more processor such as one or more central processing units (CPUs), such as single-core or multi-core CPUs, graphics processing units (GPUs), digital signal processor (DSPs), neural processing unit (NPUs), multimedia processing units, and/or the like. Instructions executed by the processing circuitry of controller 206 may be loaded, for example, from memory 260 and may cause the processing circuitry to perform the operations attributed to processing circuitry in this disclosure. In some examples, the processing circuitry of controller 206 may be based on an ARM or RISC-V instruction set.

An NPU is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

The processing circuitry of controller 206 may also include one or more sensor processing units associated with LiDAR system 202, camera 204, and/or sensor(s) 208. For example, the processing circuitry may include one or more image signal processors associated with camera 204 and/or sensor(s)2108, and/or a navigation processor associated with sensor(s) 208, which may include satellite-based positioning system components (e.g., GPS or GLONASS) as well as inertial positioning system components. In some aspects, sensor(s) 208 may include direct depth sensing sensors, which may function to determine a depth of or distance to objects within the environment surrounding processing system 200 (e.g., surrounding a vehicle).

Processing system 200 also includes memory 260, which is representative of one or more static and/or dynamic memories, such as a dynamic random access memory, a flash-based static memory, and the like. In this example, memory 260 includes computer-executable components, which may be executed by one or more of the aforementioned components of processing system 200.

Examples of memory 260 include random access memory (RAM), read-only memory (ROM), or a hard disk. Examples of memory 260 include solid state memory and a hard disk drive. In some examples, memory 260 is used to store computer-readable, computer-executable software including instructions that, when executed, cause a processor to perform various functions described herein. In some cases, memory 260 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 260 store information in the form of a logical state.

In the example of FIG. 2, memory 260 stores point cloud images 266 and camera images 268. Point cloud images 266 refer to the raw sensor data from LiDAR system 202, and camera images 268 refer to the raw sensor data from camera 204. Again, it may be possible to use one, both, other, or additional raw sensor data than point cloud images 266 and camera images 268.

The processing circuitry of controller 206 may access point cloud images 266 and camera images 268 from memory 260 and process point cloud images 266 and camera images 268 to generate point cloud feature data and camera image feature data. The processing circuitry may be configured to utilize the point cloud feature data and the camera image feature data to generate BEV object feature data. For instance, for point cloud images 266, the processing circuitry may flatten projection of the 3D feature data to generate LiDAR BEV features. Camera images 268 may be considered as being in perspective view (PV). The processing circuitry may project the perspective view to the BEV to generate camera BEV features.

For object detection, the processing circuitry of controller 206 may be configured to implement an object detection pipeline. In general, the input to the object detection pipeline may be point cloud images 266 (e.g., the point cloud data) and camera images 268 (e.g., the camera image data). The object detection pipeline generates a first set of BEV feature data (e.g., LiDAR BEV features) based on the point cloud data and a second set of BEV feature data (e.g., camera BEV features) based on the camera image data. The object detection pipeline includes an object encoder that receives the first set of BEV feature data and the second set of BEV feature data as inputs and generates object tokens (also called BEV object tokens). In some techniques, an object decoder receives the object tokens as inputs, and output object detection information (e.g., information about where objects are located, whether objects are moving, determines object type, etc.). Accordingly, the object tokens may be considered as a set of information used for object detection in image data.

In one or more examples, the object detection pipeline includes trained neural network models (simply referred to as trained models) that the processing circuitry applies to data. For instance, the object encoder and the object decoder may be trained models that the processing circuitry executes. There may be other trained models for generating the first set of BEV feature data (e.g., LiDAR BEV features) and the second set of BEV feature data (e.g., camera BEV features).

In some cases, the trained models used in the object detection pipeline may not accurately differentiate between real objects and spoof objects, or may not identify long-range objects. In accordance with one or more examples described in this disclosure, the processing circuitry of controller 206 may be further configured to apply (e.g., execute) a transformer encoder (e.g., a trained neural network model for the transformer encoder) to the feature data generated by the object encoder. The transformer encoder may be trained using a vast database that includes real objects, spoof objects, and/or long-range objects. The output from the transformer encoder may be object descriptor tokens that are indicative of information used for object detection in the image data, where this information is useable for classifying real objects (e.g., determine whether objects are real objects, including long-range objects, or spoof objects).

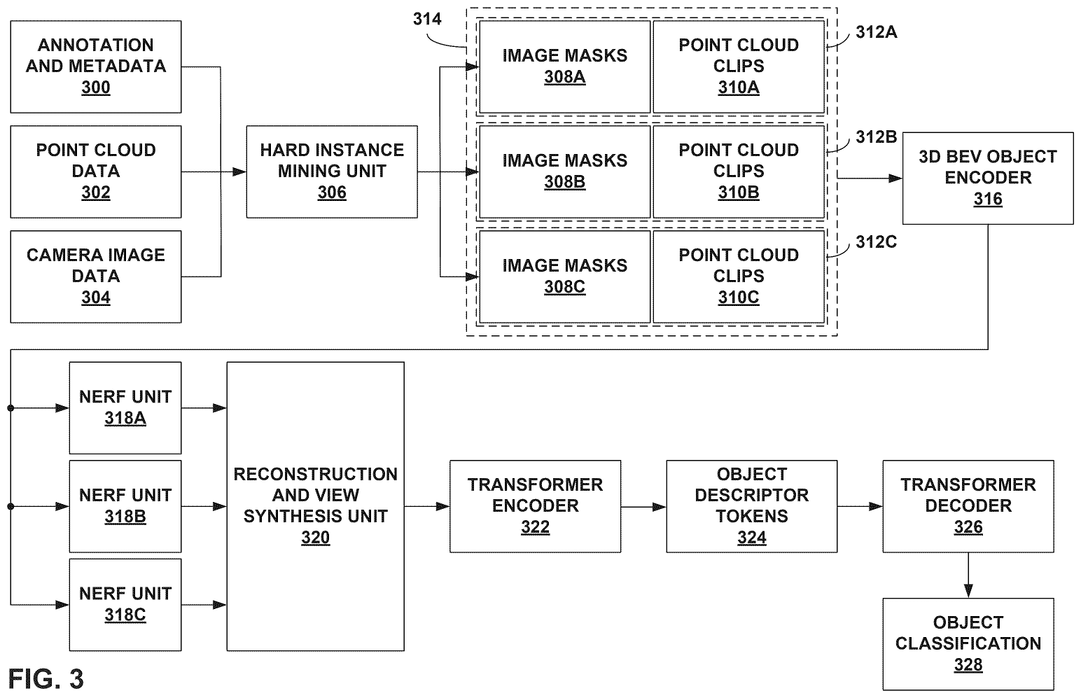

FIG. 3 is a flow diagram illustrating an example of training a transformer encoder in accordance with one or more examples described in this disclosure. The example flow diagram of FIG. 3 may be performed in one or more servers that are separate from vehicle 102. For example, the one or more servers may operate on training image data to generate a trained transformer encoder and possibly a trained transformer decoder that vehicle 102 including controller 114 or controller 206 of vehicle 102 may receive. The processing circuitry of controller 114 or controller 206 may then execute the trained transformer encoder and/or trained transformer decoder. In some examples, the one or more servers may retrain the transformer encoder and the transformer decoder based on new image data (e.g., new training data).

As illustrated, the one or more servers may receive annotation and metadata 300, point cloud data 302, and camera image data 304. Point cloud data 302 and camera image data 304 may be examples of training data. For instance, a LiDAR system may generate point cloud data 302 for training purposes, and a camera may capture camera image data 304 for training purposes.

Annotation and metadata 300 may include annotations and metadata of point cloud data 302 and camera image data 304 for contextualization. Examples of annotation and metadata 300 may include user provided input such as conditions in which the image data was captured (e.g., weather, traffic, lighting, etc.), whether virtual objects (e.g., reflections of objects) are present, whether there are long-range objects, etc.

Hard instance mining unit 306 may receive annotation and metadata 300, point cloud data 302, and camera image data 304. Hard instance mining unit 306 may be tasked with generating database 214, which may be referred to as a sensor-specific knowledge database. That is, database 214 may provide a rich repository of annotated samples encompassing diverse long-range objects and spoof objects captured in different environmental conditions.

Hard instance mining unit 306 may be configured to identify instances within the training data (e.g., point cloud data 302 and camera image data 304) that present challenges for object detection. For instance, hard instance mining unit 306 may identify training data where there are real objects, training data where there are spoof objects, and training data where there are long-range objects. That is, the categories of interest along which hard instance mining unit 306 may identify training data include real versus spoof objects, objects at long ranges along with other weather elements, reflections and glares, etc.

Accordingly, one of the tasks of hard instance mining unit 306 may be to better ensure that there is sufficient training data for each category of interest to generate databased 214. Use of hard instance mining unit 306 to ensure that there is sufficient training data for each category of interest to generate database 214 is one example, and other techniques are possible.

Database 214 may store real object information 312A spoof object information 312B, and long-range object information 312C. For ease of example, real object information 312A spoof object information 312B, and long-range object information 312C are illustrated. However, not all three are necessary in every example, and there may be more or fewer such object information in database 214. For purposes of description only, the example techniques are described with respect to real object information 312A spoof object information 312B, and long-range object information 312C.

In this manner, the one or more servers may generate database 214. In accordance with one or more examples, database 214 may be usable for enriching scene understanding and elevating analytical precision, thereby improving the ability to discern between real and spoof objects while enhancing detection performance for long-range objects under varying environmental conditions. That is, training using database 214 may greatly enhance the 3D object detection (3DOD) by providing a rich repository of annotated samples encompassing diverse long-range objects and environmental conditions.

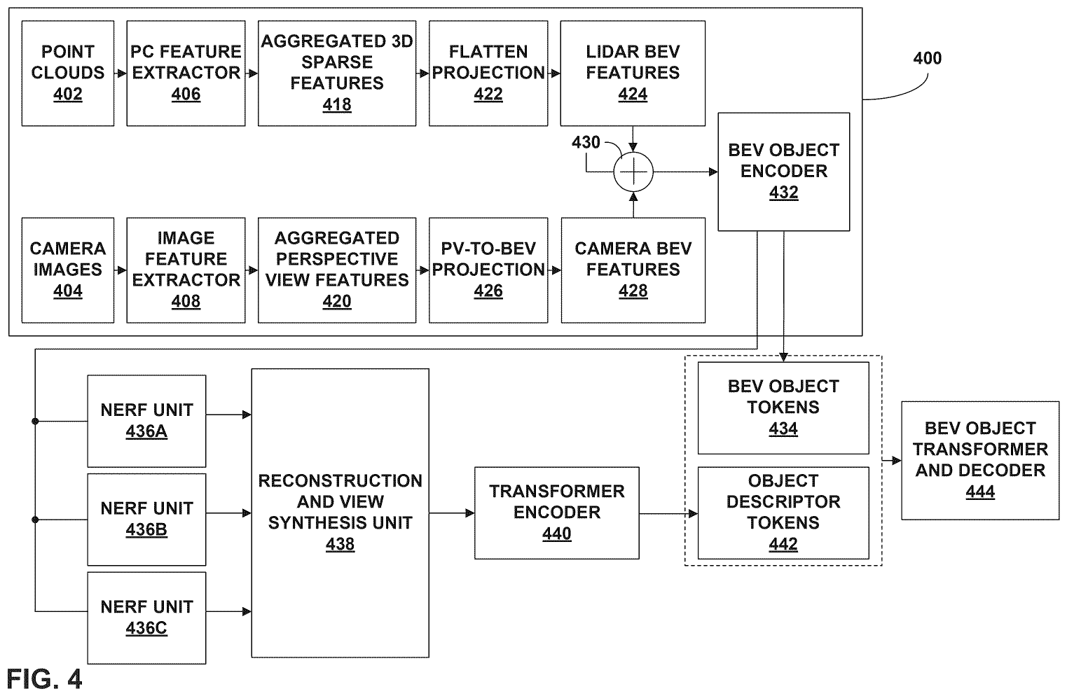

As described in more detail, through exposure to database 214, transformer encoder 322 and transformer decoder 326 may refine understanding of object geometries, spatial relationships, and semantic contexts, thereby improving ability to accurately detect and classify objects even at considerable distances. By training on a wide range of scenarios, including challenging conditions such as low light, adverse weather, and occlusions, transformer encoder 322 and transformer decoder 326 become more robust and adaptable in real-world settings. Additionally, database 214 facilitates continuous learning, allowing transformer encoder 322 and transformer decoder 326 to incorporate new knowledge and update detection algorithms over time, ensuring ongoing improvements in performance and reliability. Stated another way, the utilization of a comprehensive knowledge database 214, that has a vast variety of annotated samples, consisting of long-range objects, spoof/virtual objects in different and environmental conditions, may augment the capabilities of the 3D object detection (3DOD) decoder, described in more detail with respect to FIG. 4.

For example, as described in more detail, the processing circuitry of controller 114 or 206 may receive transformer encoder 322 and/or transformer 226 that have trained using the example techniques of FIG. 3. In runtime of vehicle 102, the processing circuitry may execute transformer encoder 322 and/or transformer decoder 326, or a trained model that includes transformer decoder 326, to perform more accurate object detection.

As illustrated, real object information 312A may include image masks 308A and point cloud clips 310A. Image masks 308A may include part of the image data that has real objects from the camera image data 304, and point cloud clips 310A may include part of the point cloud that has real objects from point cloud data 302. Spoof object information 312B may include image masks 308B and point cloud clips 310B. Image masks 308B may include part of the image data that has spoof objects from the camera image data 304, and point cloud clips 310B may include part of the point cloud that has spoof objects from point cloud data 302. Long-range object information 312C may include image masks 308C and point cloud clips 310C. Image masks 308C may include part of the image data that has long-range objects from the camera image data 304, and point cloud clips 310C may include part of the point cloud that has long-range objects from point cloud data 302.

An image feature extractor that encodes and lifts to 3D space image masks 308A, 308B, and 308C to generate image BEV features. For point clouds, a point cloud feature extract may extract 3D features by passing point cloud clips 310A, point cloud clips 310B, and point cloud clips 310C through a voxel encoder to get 3D sparse LiDAR features. The sparse lidar features are flattened to produce point cloud BEV features. 3D BEV object encoder 316 may generate object feature data from the image BEV features and the point cloud BEV features.

As described above, image masks 308A, 308B, and 308C and point cloud clips 310A, 310B, and 310C may include part of the image. Also, the BEV features may be represented in two-dimensions since BEV images are two-dimensional from a perspective of looking down. However, the objects that are to be detected in real-world are in a three-dimensional space.

In one or more examples, neural radiance fields (NeRF) units 318A, 318B, and 318C may receive the object feature data from 3D BEV object encoder 316 to reconstruct a three-dimensional volumetric representation. In one or more examples, each one of NeRF units 318A, 318B, and 318C may correspond to real object information 312A spoof object information 312B, and long-range object information 312C, and may complete the scene geometry from partial objects and generate a volumetric representations of the object along with visual attributes. That is, there may be a separate NeRF unit for each category in the knowledge database 214.

In general, NeRF units 318A, 318B, and 318C utilize NeRF techniques for scene reconstruction from partial objects, generating volumetric representations capturing scene geometry and appearance effectively. NeRF techniques may capture detailed geometry and visual attributes, resulting in a unified and comprehensive representation of the objects, which may be helpful in detecting and localizing long-range objects, as well as identifying spoof objects that should be excluded for object detection. For example, the output from NeRF units 318A, 318B, and 318C may be a continuous five-dimensional function of the object, where each point in three-dimensional space is associated with both color and opacity values. Such techniques may effectively capture a geometry and appearance of a scene in a unified representation.

NeRF units 318A, 318B, and 318C use a neural network architecture to learn the volumetric representation of the scene. This neural network is trained with the two-dimensional images masks (e.g., image masks 308A, 308B, and 308C when used as training data for NeRF units 318A, 318B, and 318C) paired with corresponding three-dimensional point cloud clips (e.g., point cloud clips 310A, 310B, and 310C when used as training data for NeRF units 318A, 318B, and 318C) to complete the object geometry from two-dimensional images.

Once the neural network has been trained, NeRF units 318A, 318B, and 318C may efficiently render views of the scene from arbitrary viewpoints. By evaluating the learned volumetric function along rays corresponding to new camera positions, NeRF units 318A, 318B, and 318C can generate novel 3D scene geometries to enrich the knowledge database 214. That is, database 214 may include three-dimensional point cloud data and two-dimensional camera image data. With NeRF units 318A, 318B, and 318C, the three-dimensional point cloud data and the two-dimensional camera image data can be represented in a volumetric grid, and objects can be visualized from different perspectives (e.g., different viewing angles).

NeRF unit 318A may be trained to generate volumetric grid for real objects, NeRF unit 318B may be trained to generate volumetric grid for spoof objects, and NeRF unit 318C may be trained to generate volumetric grid for long-range objects. Accordingly, in some examples, each of NeRF units 318A, 318B, and 318C may each receive the object feature data from 3D BEV object encoder 316, but may generate volumetric grid that for real objects, spoof objects, or long-range objects, respectively.

Use of NeRF units 318A, 318B, and 318C is provided as an example. There may be other ways in which to generate a volumetric grid based on object feature data from 3D BEV object encoder 316, and using NeRF techniques is one example. Also, in some examples, it may not be necessary to generate a volumetric grid if using the object feature data is sufficient. In such examples, NeRF units 318A, 318B, and 318C may not be necessary.

Reconstruction and view synthesis unit 320 may receive the volumetric grid from NeRF unit 318A, 318B, and 318C and process them for input to transformer encoder 322. Reconstruction and view synthesis unit 320 is not necessary in all examples.

Transformer encoder 322 may operate on the reconstructed 3D scene, which is represented as a volumetric grid (e.g., the outputs of NeRF units 318A, 318B, and 318C). Using self-attention mechanisms, transformer encoder 322 may capture spatial and textural relationships within the object. By iteratively attending to different parts of the input scene, transformer encoder 322 may learn to extract high-level features that captures object characteristics such as shape, texture, and spatial arrangement. These extracted features may serve as a compact and informative representation of the object, encoding the key information for subsequent classification tasks.

For instance, transformer encoder 322 may be a trained transformer encoder that has been trained based on classified image data classifying images as including one or more of real objects, spoof objects, or long-range objects (e.g., using real object information 312A, spoof objection information 312B, and long-range object information 312C). Transformer encoder 322 may extract high-level feature data from the image data, the high-level feature data including shape, texture, and spatial arrangement of objects in the image data. As illustrated, the output of transformer encoder 322 is object descriptor tokens 324.

Object descriptor tokens 324 may include the extracted features that capture object characteristics such as shape, texture, and spatial arrangement. In general, object descriptor tokens 324 may be considered as a set of information being usable for classifying real objects (e.g., usable for determining whether there is a real object, including long-range object in the image data, or whether there is a spoof object that should not be classified as a real object). For example, object descriptor tokens 324 may be feature vectors that extract similarity to different types of objects such as True/False (e.g., real or spoof object), Near vs Far (e.g., near-range or long-range object, etc. based on the NeRF models (e.g., NeRF units 318A, 318B, and 318C). The NeRF models hold a knowledge base specific to each object strata. This is used to extract similarity descriptors, referred to as object descriptor tokens 324, which are further used in downstream tasks.

Transformer decoder 326 may receive object descriptor tokens 324 as input. Transformer decoder 326, which may also be a neural network model that is trained, complements the feature extraction process by performing object classification based on the extracted features (e.g., based on object descriptor tokens 324). Similar to transformer encoder 322, transformer decoder 326 may employ self-attention mechanisms to analyze the extracted features (e.g., object descriptor tokens 324) and capture relevant patterns for classification (e.g., for classifying real objects, including long-range objects, or spoof objects). Transformer decoder 326 may learn to attend to different parts of the feature space, effectively discerning between real and spoof objects based on learned representations. Through an iterative decoding process, transformer decoder 326 may refine predictions and generate confidence scores for each object class (e.g., real object or spoof object). Transformer decoder 326 may also be able to extract discernable representation, from transformer encoder 322, about true and false object predictions in case of long-range objects.

For example, as illustrated, the output of transformer decoder 326 is object classification 328. Object classification 328 may indicate whether an object is classified as real object, including long-range object, or spoof object. The one or more servers may then compare object classification 328 with the actual classification of the object based on annotation and metadata 300. If the classification is incorrect, the one or more servers may generate an error signal that is used to train transformer encoder 322 and/or transformer decoder 326.

FIG. 4 is a flow diagram illustrating an example of object detection in accordance with one or more examples described in this disclosure. For instance, the processing circuitry of controller 114 or 206 in vehicle 102 may be configured to perform the example techniques of FIG. 4.

FIG. 4 illustrates partial object detection pipeline 400 which may be part of a larger object detection pipeline, as one non-limiting example. For instance, partial object detection pipeline 400 may output BEV object tokens 434, which in some examples, may be similar to BEV object tokens generated from other object detection pipelines. However, in accordance with one or more examples described in this disclosure, rather than relying solely on BEV object tokens 434, the processing circuitry may output object detection information based on BEV object tokens 434 and object descriptor tokens 442, where object descriptor tokens 442 are usable for classifying real objects, and in some examples, also identifying long-range objects.

Partial object detection pipeline 400 being part of a larger object detection pipeline is described as one example, and should not be considered limiting. Partial object detection pipeline 400 may be a different than illustrated, and include more or fewer components. Moreover, for ease of description, the example techniques are described as supplementing the output from a part of a standard object detection pipeline. Such description is provided for ease of explanation. In one or more examples, the example techniques described in this disclosure may be integrated into the object detection pipeline. Accordingly, the flow diagram of FIG. 4 is provided as one example, and the processing circuitry may implement an operational flow that is different than the example of FIG. 4, and still be consistent with the techniques described in this disclosure.

In the example of FIG. 4, the processing circuitry may acquire point clouds 402 and acquire camera images 404. The point clouds 402 and camera images 404 may constitute raw data acquired by sensors, such as LiDAR system 202 and camera 204, respectively, such as point cloud images 266 and camera images 268 that are captured while vehicle 102 is operational and the ADAS system is assisting the driver.

The processing circuitry may perform point-cloud feature extraction 406 on the acquired point clouds and perform image features extraction 408 on the acquired images. The processing circuitry may, for example, identify shapes, lines, or other features in the point clouds and images that may correspond to real-world objects of interest. Performing feature extraction on the raw data may reduce the amount of data in the frames as some information in the point clouds and images may be removed. For example, data corresponding to unoccupied voxels of a point cloud may be removed.

The processing circuitry may store a set of aggregated 3D sparse features 418. That is, the processing circuitry may maintain a buffer with point cloud frames. The point clouds in the buffer, due to feature extraction and/or down sampling, may have reduced data relative to the raw data acquired by LiDAR system 202. The processing circuitry may add new point clouds to the buffer at a fixed frequency and/or in response to vehicle 102 having moved a threshold unit of distance.

The processing circuitry may store a set of aggregated perspective view features 420. That is, the processing circuitry may maintain a buffer with sets of images. The images in the buffer, due to feature extraction and/or down sampling, may have reduced data relative to the raw data acquired by camera 204. The processing circuitry may add new images to the buffer at a fixed frequency and/or in response to vehicle 102 having moved a threshold unit of distance.

The processing circuitry may flatten projection 422 on the point cloud frames, e.g., on the aggregated 3D sparse features. The processing circuitry may perform perspective view (PV)-to-BEV projection 426 on the images, e.g., the aggregated perspective view features. Flatten projection converts the 3D point cloud data into 2D data, which creates a birds-eye-view (BEV) perspective of the point cloud, e.g., data indicative of LiDAR BEV features 424 in the point clouds. PV-to-BEV projection converts the image data into 2D BEV data, using for example matrix multiplication, which creates data indicative of camera BEV features 428.

As illustrated in FIG. 4, the processing circuitry may combine using combining unit 430 LiDAR BEV features 424 and camera BEV features 428, and output the result to BEV object encoder 432. BEV object encoder 432 may be similar to 3D BEV object encoder 316 of FIG. 3. That is, BEV object encoder 432 may generate BEV object tokens 434 similar to the manner in which 3D BEV object encoder 316 generated feature data.

In one or more examples, BEV object tokens may be considered as a first set of information used for object detection in the image data. Stated another way, the processing circuitry may be configured to generate BEV object feature data from the image data, including BEV object tokens 434. The BEV object tokens 434 may be indicative of a first set of information used for object detection in the image data. To generate the BEV object feature data, the processing circuitry may be configured to apply image feature data generated from the image data to a BEV object encoder 432.

The image data may include point cloud data (e.g., point cloud images 266) and camera image data (e.g., camera images 268). The processing circuitry may be configured to generate a first set of BEV feature data based on the point cloud data (e.g., LiDAR BEV features 424) and a second set of BEV feature data based on the camera image data (e.g., camera BEV features 428). To generate the BEV object feature data from the image data (e.g., including BEV object tokens 434), the processing circuitry (e.g., using BEV object encoder 432) may be configured to generate the BEV object feature data based on the first set of BEV feature data (e.g., LiDAR BEV features 424) and the second set of BEV feature data (e.g., camera BEV features 428).

In accordance with one or more examples, NeRF units 436A, 436B, and 436C may receive at least some of the BEV object feature data that BEV object encoder 432 generated. NeRF units 436A, 436B, and 436C may be similar to NeRF units 318A, 318B, and 318C. For instance, the processing circuitry may receive NeRF units 318A, 318B, and 318C from the one or more servers, and are represented as NeRF units 436A, 436B, and 436C in FIG. 4.

Similar to NeRF units 318A, 318B, and 318C, NeRF units 436A, 436B, and 436C may be configured to generate volumetric representations of the image data based on the BEV object feature data, including BEV object tokens 434 generated by BEV object encoder 432. The volumetric representations may be specialized for real objects, spoof objects, and long-range objects, in this example.

In some examples, instead of using the output from BEV object encoder 432, NeRF units 436A, 436B, and 436C may receive the image data (e.g., point clouds 402 and camera image 404). In such examples, NeRF units 436A, 436B, and 436C may have been trained to generate the volumetric representations based on the image data.

Reconstruction and view synthesis unit 438 may receive the output from NeRF units 436A, 436B, and 436C and synthesize the outputs for input to transformer encoder 440. Accordingly, the processing circuitry may be configured to generate an input for transformer encoder 440 based on at least some of the BEV object feature data (e.g., output from NeRF units 436A, 436B, or 436C) or the image data (e.g., point clouds 402 or camera images 404). For instance, to generate the input for the transformer encoder 440, the processing circuitry may be configured to apply one or more neural radiance field (NeRF) neural networks (e.g., via NeRF units 436A, 436B, or 436C) to the at least some of the BEV object feature data from BEV object encoder 432 or the image data (e.g., point clouds 402 or camera images 404) to generate the input for the transformer encoder 440.

The use of NeRF units 436A, 436B, and 436C and/or reconstruction and view synthesis unit 438 may not be required in all examples. For instance, to generate the input for the transformer encoder 440, the processing circuitry may be configured to output the BEV feature data from BEV object encoder 432 to transformer encoder 440, or may be configured to utilize some technique other than NeRF techniques to generate a volumetric representation or some other representation that can form as the input to transformer encoder 440.

Transformer encoder 440 may be similar to transformer encoder 322 of FIG. 3. That is, transformer encoder 440 may be a trained transformer encoder that has been trained based on classified image data classifying images as including one or more of real objects, spoof objects, or long-range objects. For example, the processing circuitry may receive transformer encoder 322 from the one or more servers, and is represented as transformer encoder 440 in FIG. 4.

As illustrated, the output from transformer encoder 440 is object descriptor tokens 442. Similar to object descriptor tokens 324 of FIG. 3, object descriptor tokens may be indicative of a second set of information used for object detection in the image data. The second set of information may be usable for classifying real objects (e.g., determine real objects, including long-range objects, and avoid classifying spoof objects as real objects). For instance, to generate object descriptor tokens 442 based on applying the transformer encoder 440, the processing circuitry may be configured to extract high-level feature data from the image data, the high-level feature data including shape, texture, and spatial arrangement of objects in the image data.

The processing circuitry may be configured to output object detection information based on the BEV object tokens 434 and the object descriptor tokens 442. For example, BEV object transformer and decoder 444 may receive both BEV object tokens 434 and object descriptor tokens 442 and output object detection information such as identification and localization of objects, information about where objects are located, whether objects are moving, determines object type, etc. In one or more examples, BEV object transformer and decoder 444 may be a combination of transformer decoder 326 and an object decoder that is configured to output object detection information.

The object detection output may be more accurate as compared to other techniques because BEV object transformer and decoder 444 uses object descriptor tokens 442, which are generated to classify real objects including long-range objects, and avoid classifying spoof objects as real objects, in addition to BEV object tokens 434. In this manner, transformer encoder 440 is supplemented or integrated into the object detection pipeline for a robust pipeline that is immune to incorrectly identifying spoof objects (e.g., fake, virtual, or false objects). The object descriptor tokens 442 may be concatenated with the BEV object tokens 434 and fed to BEV object transformer and decoder 444 to get the final 3D object detection outputs.

In the above description for FIG. 4, the processing circuitry may be operating during run-time of vehicle 102. However, it may be possible to keep retraining the various models illustrated in FIG. 4. For instance, transformer encoder 440 may be a trained transformer that was trained using the example of FIG. 3. In one or more examples, BEV object encoder 432, transformer encoder 440, and the BEV object transformer and decoder 444 may be trained end-to-end prior to run-time operation of the processing circuitry. For example, point clouds 402 and camera images 404 may be used as training data to end-to-end train the example of FIG. 4, where point clouds 402 and camera images 404 are annotated with information indicating whether objects are spoof objects and long-range objects, in addition to information if the objects are real objects. In this manner, the example techniques may promote establishing a real-time feedback loop between field detections of BEV object encoder 432 and the object descriptor tokens from transformer encoder 440, implementing incremental learning, and utilizing active learning strategies for model refinement, ensuring continuous improvement and adaptation to evolving environments.

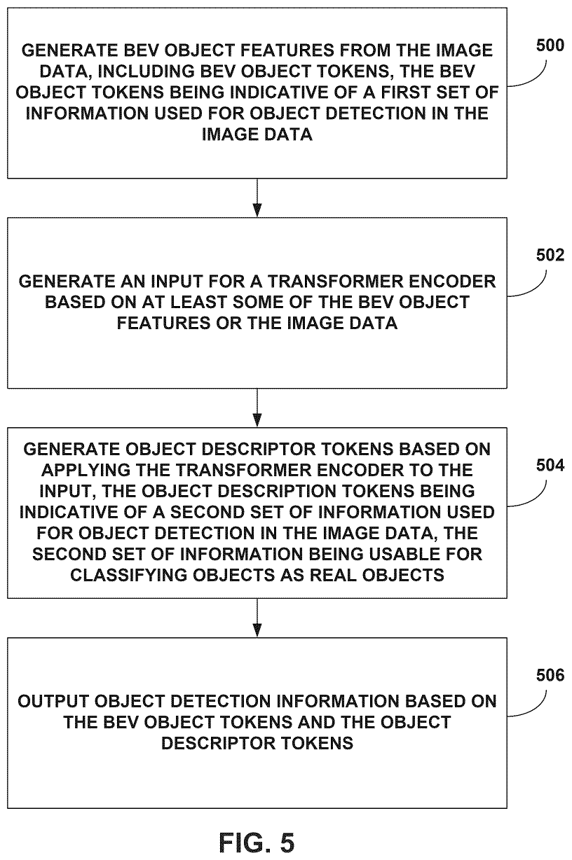

FIG. 5 is a flowchart illustrating an example method for object detection in accordance with one or more examples described in this disclosure. The example of FIG. 5 is described with respect to the processing circuitry of controller 114 or controller 206, with reference to FIG. 4. For instance, memory 260 or other memory (e.g., one or more memories) may be configured to store image data (e.g., point cloud images 266, camera images 268, point clouds 402, or camera images 404).

The processing circuitry may be configured to generate BEV object feature data from the image data, including BEV object tokens 434, the BEV object tokens 434 being indicative of a first set of information used for object detection in the image data (500). For example, to generate the BEV object feature data, the processing circuitry may be configured to apply image feature data generated from the image data to a BEV object encoder 432. As an example, the image data includes point cloud data and camera image data. The processing circuitry may be configured to generate a first set of BEV feature data (e.g., LiDAR BEV features 424) based on the point cloud data and a second set of BEV feature data (e.g., camera BEV features 428) based on the camera image data. To generate the BEV object feature data from the image data (e.g., including BEV object tokens 434), the processing circuitry may be configured to generate the BEV object feature data based on the first set of BEV feature data and the second set of BEV feature data.

The processing circuitry may be configured to generate an input for a transformer encoder 440 based on at least some of the BEV object feature data or the image data (502). In some examples, the input for transformer encoder 440 may be the output of BEV object encoder 432 or other inputs generated from point clouds 402 or camera images 404. In some examples, to generate the input for the transformer encoder 440, the processing circuitry may be configured to apply one or more neural radiance field (NeRF) neural networks to the at least some of the BEV object feature data (e.g., using NeRF units 436A, 436B, and 436C) or the image data (e.g., point clouds 402 or camera images 404) to generate the input for the transformer encoder 440.

The processing circuitry may be configured to generate object descriptor tokens 442 based on applying the transformer encoder 440 to the input, the object descriptor tokens 442 being indicative of a second set of information used for object detection in the image data, the second set of information being usable for classifying real objects (504). In one or more examples, the transformer encoder 440 may be a trained transformer encoder that has been trained based on classified image data classifying images as including one or more of real objects, spoof objects, or long-range objects. That is, transformer encoder 440 may be transformer encoder 322 of FIG. 3. Also, in some examples, to generate object descriptor tokens 442 based on applying the transformer encoder 440 to the input, the processing circuitry may be configured to extract high-level feature data from the image data, the high-level feature data including shape, texture, and spatial arrangement of objects in the image data.

The processing circuitry may be configured to output object detection information based on the BEV object tokens 434 and the object descriptor tokens 442 (506). For example, to output object detection information, the processing circuitry may be configured to apply the BEV object tokens 434 and the object descriptor tokens 442 to a BEV object transformer and decoder 444. The processing circuitry may concatenate, as one example, BEV object tokens 434 and object descriptor tokens 442, and output the result to BEV object transformer and decoder 444 to output object detection information (e.g., identification and localization of objects, such as information about where objects are located, whether objects are moving, determines object type, etc.).

As described, the BEV object encoder 432, transformer encoder 440, and the BEV object transformer and decoder 444 may be trained end-to-end prior to run-time operation of the processing circuitry. Also, the processing circuitry may be configured to control operation of vehicle 102 based on the object detection information. For instance, the processing circuitry may output autonomous operation commands to self-drive vehicle 102 and/or assist the human vehicle driver in driving based on the object detection information.

The following numbered clauses illustrate one or more aspects of the devices and techniques described in this disclosure.

Clause 1. A device for object detection, the device comprising: one or more memories configured to store image data; and processing circuitry connected to the one or more memories, the processing circuitry configured to: generate bird's-eye-view (BEV) object feature data from the image data, including BEV object tokens, the BEV object tokens being indicative of a first set of information used for object detection in the image data; generate an input for a transformer encoder based on at least some of the BEV object feature data or the image data; generate object descriptor tokens based on applying the transformer encoder to the input, the object description tokens being indicative of a second set of information used for object detection in the image data, the second set of information being usable for classifying real objects; and output object detection information based on the BEV object tokens and the object descriptor tokens.

Clause 2. The device of clause 1, wherein to generate the input for the transformer encoder, the processing circuitry is configured to: apply one or more neural radiance field (NeRF) neural networks to the at least some of the BEV object feature data or the image data to generate the input for the transformer encoder.

Clause 3. The device of any of clauses 1 and 2, wherein the transformer encoder is a trained transformer encoder that has been trained based on classified image data classifying images as including one or more of real objects, spoof objects, or long-range objects.

Clause 4. The device of any of clauses 1-3, wherein to generate the BEV object feature data, the processing circuitry is configured to apply image feature data generated from the image data to a BEV object encoder, and wherein to output object detection information, the processing circuitry is configured to apply the BEV object tokens and the object descriptor tokens to a BEV object transformer and decoder.

Clause 5. The device of clause 4, wherein the BEV object encoder, transformer encoder, and the BEV object transformer and decoder are trained end-to-end prior to run-time operation of the processing circuitry.

Clause 6. The device of any of clauses 1-5, wherein the image data includes point cloud data and camera image data, wherein the processing circuitry is configured to generate a first set of BEV feature data based on the point cloud data and a second set of BEV feature data based on the camera image data, and wherein to generate the BEV object feature data from the image data, the processing circuitry is configured to generate the BEV object feature data based on the first set of BEV feature data and the second set of BEV feature data.

Clause 7. The device of any of clauses 1-6, wherein to generate object descriptor tokens based on applying the transformer encoder to the input, the processing circuitry is configured to extract high-level feature data from the image data, the high-level feature data including shape, texture, and spatial arrangement of objects in the image data.

Clause 8. The device of any of clauses 1-7, wherein the processing circuitry is configured to control operation of a vehicle based on the object detection information.

Clause 9. The device of any of clauses 1-8, wherein object detection information comprises identification and localization of objects.

Clause 10. The device of any of clauses 1-9, wherein the device is a vehicle.

Clause 11. A method of object detection, the method comprising: generating, with processing circuitry, bird's-eye-view (BEV) object feature data from image data, including BEV object tokens, the BEV object tokens being indicative of a first set of information used for object detection in the image data; generating, with the processing circuitry, an input for a transformer encoder based on at least some of the BEV object feature data or the image data; generating, with the processing circuitry, object descriptor tokens based on applying the transformer encoder to the input, the object description tokens being indicative of a second set of information used for object detection in the image data, the second set of information being usable for classifying real objects; and outputting, with the processing circuitry, object detection information based on the BEV object tokens and the object descriptor tokens.

Clause 12. The method of clause 11, wherein generating the input for the transformer encoder comprises: applying one or more neural radiance field (NeRF) neural networks to the at least some of the BEV object feature data or the image data to generate the input for the transformer encoder.

Clause 13. The method of any of clauses 11 and 12, wherein the transformer encoder is a trained transformer encoder that has been trained based on classified image data classifying images as including one or more of real objects, spoof objects, or long-range objects.

Clause 14. The method of any of clauses 11-13, wherein generating the BEV object feature data comprises applying image feature data generated from the image data to a BEV object encoder, and wherein outputting object detection information comprises applying the BEV object tokens and the object descriptor tokens to a BEV object transformer and decoder.

Clause 15. The method of clause 14, wherein the BEV object encoder, transformer encoder, and the BEV object transformer and decoder are trained end-to-end prior to run-time operation of the processing circuitry.

Clause 16. The method of any of clauses 11-15, wherein the image data includes point cloud data and camera image data, the method further comprising generating a first set of BEV feature data based on the point cloud data and a second set of BEV feature data based on the camera image data, and wherein generating the BEV object feature data from the image data comprises generating the BEV object feature data based on the first set of BEV feature data and the second set of BEV feature data.

Clause 17. The method of any of clauses 11-16, wherein generating object descriptor tokens based on applying the transformer encoder to the input comprises extracting high-level feature data from the image data, the high-level feature data including shape, texture, and spatial arrangement of objects in the image data.

Clause 18. The method of any of clauses 11-17, wherein further comprising controlling operation of a vehicle based on the object detection information.

Clause 19. The method of any of clauses 11-18, wherein object detection information comprises identification and localization of objects.

Clause 20. One or more computer-readable storage media storing instruction thereon that when executed cause processing circuitry to: generate bird's-eye-view (BEV) object feature data from image data, including BEV object tokens, the BEV object tokens being indicative of a first set of information used for object detection in the image data; generate an input for a transformer encoder based on at least some of the BEV object feature data or the image data; generate object descriptor tokens based on applying the transformer encoder to the input, the object description tokens being indicative of a second set of information used for object detection in the image data, the second set of information being usable for classifying real objects; and output object detection information based on the BEV object tokens and the object descriptor tokens.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for object detection, the device comprising:
one or more memories configured to store image data; and
processing circuitry connected to the one or more memories, the processing circuitry configured to:
generate bird's-eye-view (BEV) object feature data from the image data, including BEV object tokens, the BEV object tokens being indicative of a first set of information used for object detection in the image data;
generate an input for a transformer encoder based on at least some of the BEV object feature data or the image data;
generate object descriptor tokens based on applying the transformer encoder to the input, the object description tokens being indicative of a second set of information used for object detection in the image data, the second set of information being usable for classifying real objects; and
output object detection information based on the BEV object tokens and the object descriptor tokens.

2. The device of claim 1, wherein to generate the input for the transformer encoder, the processing circuitry is configured to:
apply one or more neural radiance field (NeRF) neural networks to the at least some of the BEV object feature data or the image data to generate the input for the transformer encoder.

3. The device of claim 1, wherein the transformer encoder is a trained transformer encoder that has been trained based on classified image data classifying images as including one or more of real objects, spoof objects, or long-range objects.

4. The device of claim 1,
wherein to generate the BEV object feature data, the processing circuitry is configured to apply image feature data generated from the image data to a BEV object encoder, and
wherein to output object detection information, the processing circuitry is configured to apply the BEV object tokens and the object descriptor tokens to a BEV object transformer and decoder.

5. The device of claim 4, wherein the BEV object encoder, transformer encoder, and the BEV object transformer and decoder are trained end-to-end prior to run-time operation of the processing circuitry.

6. The device of claim 1, wherein the image data includes point cloud data and camera image data, wherein the processing circuitry is configured to generate a first set of BEV feature data based on the point cloud data and a second set of BEV feature data based on the camera image data, and wherein to generate the BEV object feature data from the image data, the processing circuitry is configured to generate the BEV object feature data based on the first set of BEV feature data and the second set of BEV feature data.

7. The device of claim 1, wherein to generate object descriptor tokens based on applying the transformer encoder to the input, the processing circuitry is configured to extract high-level feature data from the image data, the high-level feature data including shape, texture, and spatial arrangement of objects in the image data.

8. The device of claim 1, wherein the processing circuitry is configured to control operation of a vehicle based on the object detection information.

9. The device of claim 1, wherein object detection information comprises identification and localization of objects.

10. The device of claim 1, wherein the device is a vehicle.

11. A method of object detection, the method comprising:
generating, with processing circuitry, bird's-eye-view (BEV) object feature data from image data, including BEV object tokens, the BEV object tokens being indicative of a first set of information used for object detection in the image data;
generating, with the processing circuitry, an input for a transformer encoder based on at least some of the BEV object feature data or the image data;
generating, with the processing circuitry, object descriptor tokens based on applying the transformer encoder to the input, the object description tokens being indicative of a second set of information used for object detection in the image data, the second set of information being usable for classifying real objects; and
outputting, with the processing circuitry, object detection information based on the BEV object tokens and the object descriptor tokens.

12. The method of claim 11, wherein generating the input for the transformer encoder comprises:
applying one or more neural radiance field (NeRF) neural networks to the at least some of the BEV object feature data or the image data to generate the input for the transformer encoder.

13. The method of claim 11, wherein the transformer encoder is a trained transformer encoder that has been trained based on classified image data classifying images as including one or more of real objects, spoof objects, or long-range objects.

14. The method of claim 11,
wherein generating the BEV object feature data comprises applying image feature data generated from the image data to a BEV object encoder, and
wherein outputting object detection information comprises applying the BEV object tokens and the object descriptor tokens to a BEV object transformer and decoder.

15. The method of claim 14, wherein the BEV object encoder, transformer encoder, and the BEV object transformer and decoder are trained end-to-end prior to run-time operation of the processing circuitry.

16. The method of claim 11, wherein the image data includes point cloud data and camera image data, the method further comprising generating a first set of BEV feature data based on the point cloud data and a second set of BEV feature data based on the camera image data, and wherein generating the BEV object feature data from the image data comprises generating the BEV object feature data based on the first set of BEV feature data and the second set of BEV feature data.

17. The method of claim 11, wherein generating object descriptor tokens based on applying the transformer encoder to the input comprises extracting high-level feature data from the image data, the high-level feature data including shape, texture, and spatial arrangement of objects in the image data.

18. The method of claim 11, wherein further comprising controlling operation of a vehicle based on the object detection information.

19. The method of claim 11, wherein object detection information comprises identification and localization of objects.

20. One or more computer-readable storage media storing instruction thereon that when executed cause processing circuitry to:
generate bird's-eye-view (BEV) object feature data from image data, including BEV object tokens, the BEV object tokens being indicative of a first set of information used for object detection in the image data;
generate an input for a transformer encoder based on at least some of the BEV object feature data or the image data;
generate object descriptor tokens based on applying the transformer encoder to the input, the object description tokens being indicative of a second set of information used for object detection in the image data, the second set of information being usable for classifying real objects; and
output object detection information based on the BEV object tokens and the object descriptor tokens.
